(19) United States
(12) Patent Application Publication
(10) Pub. No.: US 2009/0293681 A1
(43) Pub. Date: Dec. 3, 2009

(54) Hammer bumper

(76) Inventor: Johnny Bert Smith, Fairmount, IN (US)

Correspondence Address: Johnny Bert Smith, 2778 E. 1050 S., Fairmount, IN, 46928, US

(21) Appl. No.: 12/386,251

(22) Filed: Apr. 16, 2009

Related U.S. Application Data
(60) Provisional application No. 61/057,970, filed on Jun. 2, 2008.

(51) Int. Cl. B25D 1/10

(52) U.S. Cl. 81/21

(57) ABSTRACT

The objective of the invention is to allow bumping or hitting fragile finished materials or finished surfaces with a hammer without denting, marking, or scratching them.

### CROSS-REFERENCE TO RELATED APPLICATIONS

This application claims the benefit under 35 U.S.C. Section 119(e) of U.S. provisional application Ser. No. 61/057,970 filed Jun. 2, 2008.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The present invention relates generally to mallets and hammers and, more particularly, is directed towards converting a hammer into a soft non-marking hammer bumper.

Attachments for hammer heads have been the subject of earlier patents, for example is the U.S. Pat. No. 2,952,284 issued to Nichols et al., which discloses an attachment for a claw hammer or the ball peen of a ball-peen hammer for converting the hammer into a mallet. The mallet attachment (7) is formed of both harder having the hardness of an ordinary mallet and then a softer rubber that can be stretched to fit over the head of a hammer. To apply the mallet attachment to the head of the a hammer, the surface of the hammer head, or preferably the surface of the neck of the attachment is moistened, as with a few drops of water.

What differs the prior art listed above from this invention, is this invention pertains to a soft hammer bumper rather than a mallet attachment which has the hardness of an ordinary mallet, this invention is manufactured entirely of a soft non-marking rubber, used on the head of a hammer when little force is needed in bumping objects of more delicate materials such as ceramic tile, glass, laminates, soft masonry stone, brass, aluminum, etc. The prior art above describes two durometer readings of rubber in which it is manufactured of, one end (insertion end) to be soft, and the impacting end to be that of a hard rubber relating to that of an ordinary mallet, in which the rubber is very hard and can damage soft, more delicate materials.

The advantages of this invention when compared to the above prior art is this invention is manufactured entirely of soft rubber, less costly, and more simple to manufacture also cannot separate upon impact being manufactured entirely of one durometer reading rather than two different types of durometer readings mentioned in the above prior art. The durometer reading of rubber that this invention is manufactured of is compared to that of a rubber band which will allow this invention to easily stretch over the head of most common used hammers of various shapes and sizes without the need of water for lubricating in which is needed for insertion of the hammer in the prior art above. This invention will attach to both the ordinary hammer and ball peen hammer without the need of having two similar designs which is described in the prior art in addition this invention will also attach to a framing and a masonry hammer. The present invention is also manufactured of a non-marking rubber that will not mark the surfaces for which it is used on.

Furthermore, the U.S. Pat. No. 3,229,738 issued to Bianchini, describes a cap or cover (14) for covering the driving head of a hammer to prevent marring or damaging to materials during a hammering operation. The cap is made of a rubber polyurethane substance and is configured to receive the head of a hammer during use. A bushing (18) is provided that fits within the cap to accommodate hammers of various sizes.

The advantages of the this invention when compared to prior art U.S. Pat. No. 3,229,738 issued to Bianchini. This invention is manufactured of rubber less costly than that of a rubber polyurethane and, does not require a bushing in which is needed in the prior art to fit various sizes, also the prior art has a thin wall at the impacting point which will lessen the time of use before requiring a replacement.

In addition the U.S. Pat. No. 3,901,296 issued to Tomac, describes a cover for a poll of a metal hammer comprising a cylindrical container made of a hard plastic material. Furthermore, several such covers can be kept in a tool box so when one of them becomes scored, another one is readily available for replacement.

The prior art directly above, being made of a hard plastic pertaining to that of a ordinary mallet, which again differs this prior art from the new art that will be manufactured of a soft rubber, and under normal use will last a very long time, the disadvantage of this prior art is the fact that you have to have replacements on hand so that you are readily able to replace one when it becomes scored.

Some or all of these disadvantages in the above prior arts may have contributed to the fact why the prior arts have never been successfully commercialized.

### BRIEF SUMMARY OF THE INVENTION

The present invention is a soft rubber attachment for a hammer adapted, designed, and constructed to cover the impacting head of the tool so as to prevent denting, marking, or scratching of the finished surface of an object being bumped in place by the hammer. The attachment is frustoconical in shape, fabricated from a relatively soft non-marking rubber and includes a hole partway through the center of one end for insertion of the head of a hammer. Effectively converting the hammer into a soft non-marking hammer bumper.

The object of the present invention is simply to, at low cost, manufacture a one part soft rubber hammer attachment that will easily attach to the impacting point of most commonly used hammers such as claw hammers, ball peen, framing, and masonry hammers of various shapes and sizes without the need of lubrications, bushings, pins, sleeves, screws, bolts or other devices indicated in prior arts.

### BRIEF DESCRIPTION OF THE SEVERAL VIEWS OF THE DRAWING

The present invention may be more readily described by references to the accompanying drawings in which:

FIG. 1 is a perspective view of the hammer bumper attached to an ordinary claw hammer.

FIG. 2 is a plain side view of the hammer bumper.

FIG. 3 is a top view showing the hole for the insertion of the hammer head.

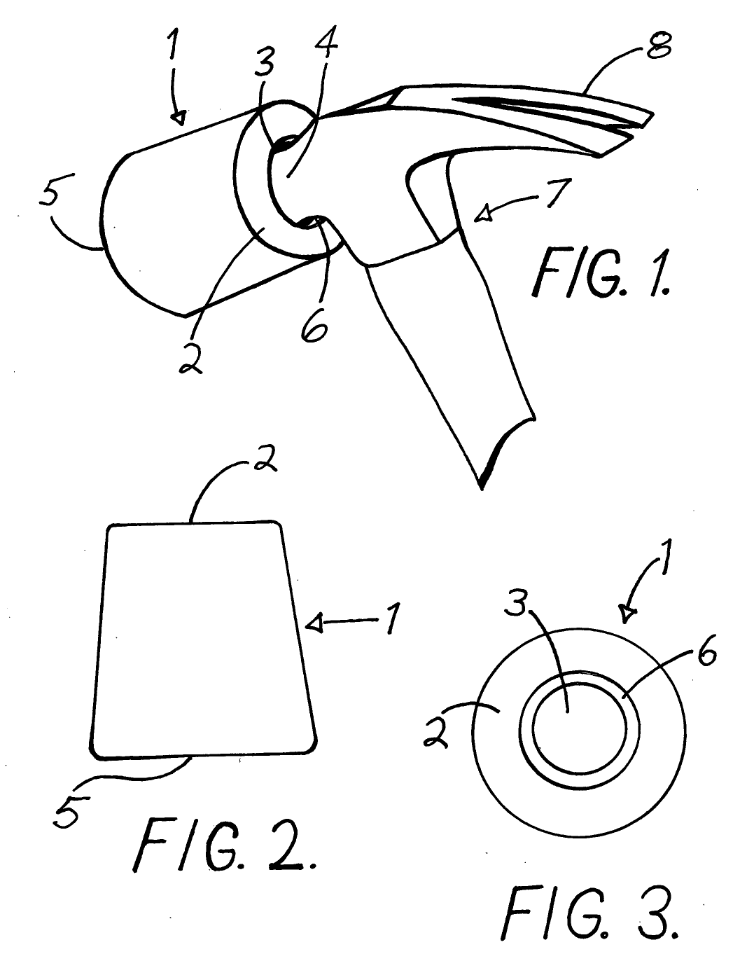

### DETAILED DESCRIPTION OF THE INVENTION

The hammer bumper 1 being described below and illustrated in the drawings is formed entirely of one durometer reading of soft non-marking rubber, and has a frustoconical shape, used on the head 4 of the hammer 7 to avoid denting, marking, or scratching finished materials. The top 2 having a flat surface with a hole 3 part way thru for the insertion of a hammer head 4. The hole 3 being 15/16 of one inch in diameter and having a depth of 1¼ inch. The bottom bumping point 5 is also made of a flat surface. The top 2 of the insertion hole 3 has a ⅛ inch bevel 6 completely around the inside top edge of the hole to allow a more easily start of the insertion of the hammer head 4. The soft rubber in which it is formed of has a durometer reading of 25 to 30 in which will allow the insertion end of the hammer bumper 1 to easily stretch over the head 4 of the most commonly used hammers that have a range from 16 to 24 oz. in weight with a the head 4 between 1 inch to 1⅜ inch in diameter or square, found on a claw 8 hammer, ball peen hammer, framing, and masonry hammer. The process in manufacturing, being made of one part, is simply to insert a soft non-marking rubber into a cavity mold of the hammer bumper 1 and having its frustoconical shape will allow for easy extraction from the mold in which it is formed in.

1. A hammer bumper allows bumping objects with a hammer without denting, marking or scratching the finished surface. Slide the hammer bumper onto the head of a claw hammer or similar hammer when needed, to avoid denting, marking, or scratching a finished surface while hammering or bumping it.

2. The hammer bumper in claim 1 is made entirely of one durometer reading of a soft non-marking rubber which will allow the hammer bumper to easily stretch over a 1 inch to 1⅜ inch in diameter or square head of a claw hammer, framing hammer, mason hammer, and ball peen hammer without the need of any lubrications, bushings, pins, sleeves, screws, bolts, or any means of attaching other than sliding the hammer bumper onto the head of the hammer as mentioned in claim 1.
